(19) United States
(12) Patent Application Publication
(10) Pub. No.: US 2008/0313666 A1
(43) Pub. Date: Dec. 18, 2008

(54) METHOD AND SYSTEM FOR CONTROLLING ACCESS TO MEDIA CONTENT DISTRIBUTED WITHIN A PREMISES

(76) Inventor: Mark Clifford Evenson, Tung Hung (HK)

Correspondence Address: COOLEY GODWARD KRONISH LLP;ATTN: Patent Group, Suite 1100, 777 - 6th Street, NW, WASHINGTON, DC, 20001, US

(21) Appl. No.: 11/764,035

(22) Filed: Jun. 15, 2007

(51) Int. Cl. H04N 7/16

(52) U.S. Cl. 725/28

(57) ABSTRACT

A method and system for controlling access to media content distributed within a premises is described. One embodiment of the system receives, at the premises, digital content and associated rating information; decodes the digital content to produce decoded content, the decoded content including a particular program from the digital content; embeds with the particular program in the decoded content a rating indicator corresponding to rating information associated with the particular program to produce rated-decoded content including the particular program; modulates the rated-decoded content to produce rated-modulated content including the particular program; and transmits the rated-modulated content to an analog television located on the premises that is capable of selectively blocking the particular program based on the embedded rating indicator. The system thus restores rating information that would otherwise be lost when digital content is converted to analog format for distribution to analog televisions within a premises.

### COPYRIGHT

A portion of the disclosure of this patent document contains material that is subject to copyright protection. The copyright owner has no objection to the facsimile reproduction by anyone of the patent disclosure as it appears in the Patent and Trademark Office patent files or records but otherwise reserves all copyright rights whatsoever.

### FIELD OF THE INVENTION

The present invention relates generally to devices and associated methods for interfacing typical consumer electronics devices and computers to sources of digital media content for the purpose of providing information, entertainment, and other value-added communications services. In particular, but not by way of limitation, the present invention relates to methods and systems for controlling access to media content distributed within a premises.

### BACKGROUND OF THE INVENTION

Advances in semiconductor and optical transmission and switching technologies have enabled the cost-effective delivery of digital entertainment and information services via broadband IP networks. These broadband IP networks are often implemented using underlying network technologies such as Digital Subscriber Line (DSL) or Fiber To The Premises (FTTP) and can also be implemented using coaxial cable or wireless facilities. In most cases existing consumer electronics equipment (e.g., television sets) and computers are not directly compatible with the broadband IP network's data formats and protocols.

One solution is to convert compressed digital content received at a premises to a standard analog signal format such as that of the National Television Standards Committee (NTSC) using suitable on-premises equipment. To distribute the analog signal to standard analog televisions throughout the premises, the analog video is modulated onto a particular carrier frequency and amplified, and the modulated, amplified signal is fed to the analog televisions via a coaxial network or via wireless transmission within the premises. By tuning to the appropriate carrier frequency, a viewer can view the analog signal from the on-premises equipment on any analog television in the household. In some versions of this solution, the on-premises equipment includes multiple decoders to produce multiple output video streams, the output of each decoder being modulated onto a unique carrier frequency. The viewer changes channels within a given stream by inputting an appropriate command to the on-premises equipment.

One disadvantage of the above solution is that it creates a parental-control problem. The programs constituting the compressed digital content are rated or classified when they are initially received at the premises. However, once they have been decoded and converted to analog format, there is no rating information on the analog signals output by the on-premises equipment. Therefore, if an adult on the premises is watching a program that the adult deems inappropriate for children, a child can access that program by simply tuning a another analog television on the premises to the channel carrying the program.

It is thus apparent that there is a need in the art for an improved method and system for controlling access to media content distributed within a premises.

### SUMMARY OF THE INVENTION

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

One illustrative embodiment of the invention is a method for controlling access to media content distributed within a premises, the method comprising receiving digital content at the premises, the digital content including separate programs; receiving at the premises, for each of the separate programs, rating information, the rating information enabling one of a plurality of rating indicators to be associated with each of the separate programs, each of the plurality of rating indicators identifying a particular class of content; decoding the digital content to produce decoded content, the decoded content including one of the separate programs; embedding with the one of the separate programs in the decoded content a rating indicator associated with the one of the separate programs to produce rated-decoded content including the one of the separate programs; modulating the rated-decoded content to produce rated-modulated content including the one of the separate programs; and transmitting the rated-modulated content to an analog television located on the premises, wherein the analog television is capable of selectively blocking the one of the separate programs based on the embedded rating indicator.

Another embodiment of the invention is a device for controlling access to media content distributed within a premises, the device comprising a digital-media interface configured to receive, at the premises, digital content including a particular program; a decoder configured to decode the digital content to produce decoded content including the particular program; a rating-insertion module configured to receive at the premises rating information for the particular program and embed with the particular program in the decoded content a rating indicator corresponding to the rating information to produce rated-decoded content including the particular program, the rating indicator being selected from a plurality of rating indicators, each rating indicator in the plurality of rating indicators identifying a particular class of content; and a modulator configured to modulate the rated-decoded content to produce rated-modulated content including the particular program for transmission to an analog television on the premises, wherein the analog television is capable of selectively blocking the particular program based on the embedded rating indicator.

These and other embodiments are described in further detail herein.

### BRIEF DESCRIPTION OF THE DRAWING

Various objects and advantages and a more complete understanding of embodiments of the present invention are described in the following Detailed Description and the appended claims when taken in conjunction with the accompanying Drawings, wherein:

FIG. 1 is a block diagram of one embodiment of the present invention;

FIG. 2 is a block diagram of a customer premises unit (CPE) constructed according to one embodiment of the present invention;

FIG. 3 is a block diagram of an exemplary media processing unit;

FIG. 4 is a block diagram of a customer premises unit (CPE) constructed according to another embodiment of the present invention;

FIG. 5 is an illustration of the inputs and outputs of one embodiment of the present invention;

FIG. 6A is a block diagram of a customer premises unit (CPE) constructed according to yet another embodiment of the present invention;

FIG. 6B is a functional diagram of a memory of the customer premises unit (CPE) shown in FIG. 6A according to an illustrative embodiment of the present invention; and

FIG. 7 is a flowchart of a method for controlling access to media content within a premises in accordance with an illustrative embodiment of the present invention.

### DETAILED DESCRIPTION

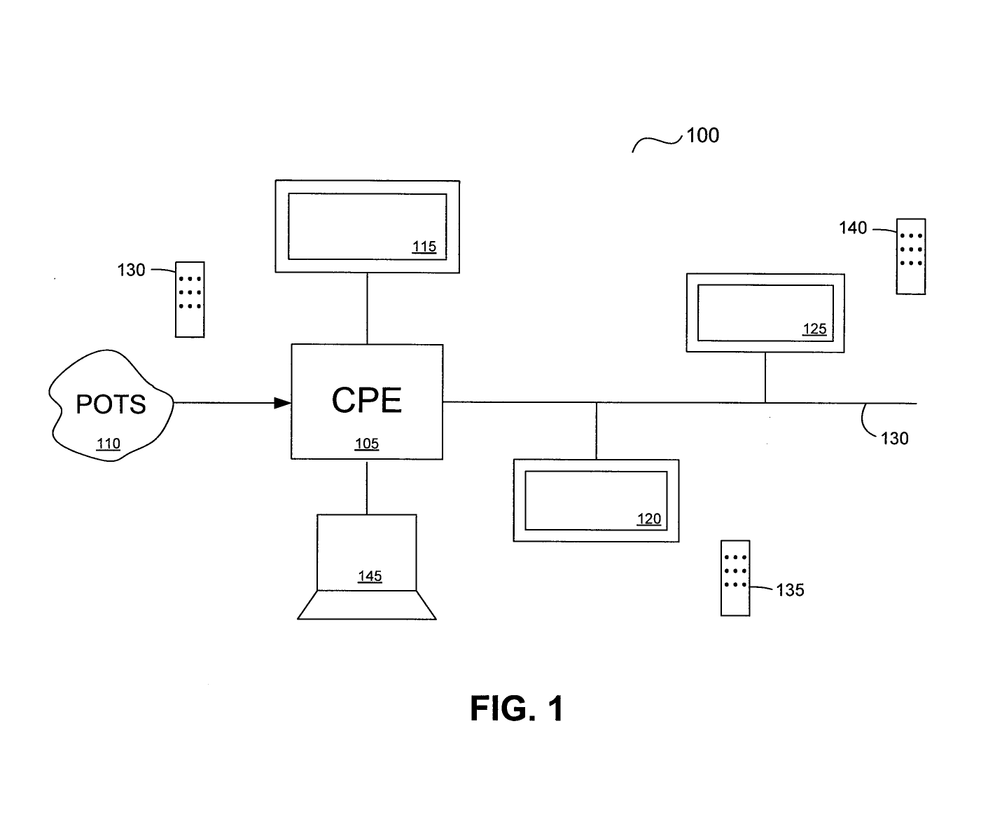

Referring now to the drawings, where like or similar elements are designated with identical reference numerals throughout the several views, and referring in particular to FIG. 1, it illustrates a block diagram of one embodiment of the present invention 100. This embodiment includes a customer premises equipment (CPE) 105 that receives data from and transmits data to a broadband IP network 110. For example, the CPE 105 could receive digital television programming over the twisted-pair telephone line common to most homes. The CPE 105 could also receive digital television programming over a fiber network, provided that the format of the data was IP based.

Regardless of the method by which it receives data, the CPE 105 can select incoming data based on use commands, decode incoming data and deliver the decoded information to one of the multiple televisions 115, 120, 125 connected to the CPE 105. This embodiment of the CPE 105 is configured to simultaneously decode three channels of programming and deliver the decoded data to three or more separate televisions 115, 120, 125. Stated differently, this CPE 105 can independently and simultaneously drive three different televisions, thereby allowing up to three different programs to be viewed or heard on each television. Note that the televisions can be replaced with any type of entertainment system, including stereos and game units.

The first television 115, in this embodiment, is directly coupled to the CPE 105 and can receive high fidelity video signals through variety of common interfaces. Additionally, the CPE 105 can directly output digital audio signal through, for example, an optical out connector. Other ways for connecting a set-top box and a television/audio system are well known to those skilled in the art and are not discussed further.

Still referring to FIG. 1, the second and third televisions 120, 125 are generally indirectly connected to the CPE 105, which means that the data is often modulated onto a VHF or UHF frequency and delivered to the televisions (henceforth the term VHF will refer those VHF and UHF frequencies that are typically used for the transmission of modulated analog television standards, such as NTSC, PAL, SECAM and the many variants of these standards in use worldwide). The second and third televisions are often remotely located from the CPE 105, and a direct connection, e.g., an unmodulated signal, would often require running new wire through a house or business. Because most consumers are hesitant to rewire their home or business, the CPE is configured to use existing in-home coaxial wiring 130 to deliver television and audio programming. (“In-home” refers to any system or device located at a customer location, whether the customer is located at a home, business or other location.) This in-home wiring 130 specifically includes a typical coaxial cable network that is common to homes that are prewired for cable television.

To independently drive multiple televisions using a digital signal, traditional systems require a set-top box at each television to decode the digital signals. But consumers are also hesitant to purchase or lease multiple set-top boxes. Accordingly, this embodiment of the CPE 105 prevents consumers from needing set-top boxes. For example, the CPE 105 can modulate a decoded digital video signal onto a VHF channel and transmit the modulated signal over the in-home wiring 130. Any television connected to the in-home wiring 130 could view the signal by tuning to the appropriate VHF channel. And no set-top box is required at that television.

By using multiple decoders in the CPE 105, different streams of data can be modulated at different VHF frequencies. For example, one stream of programming could be modulated onto channel 3 and another stream modulated onto channel 7. Thus, a television tuned to VHF channel 3 could view the first stream and a television tuned to channel 7 could view the second stream.

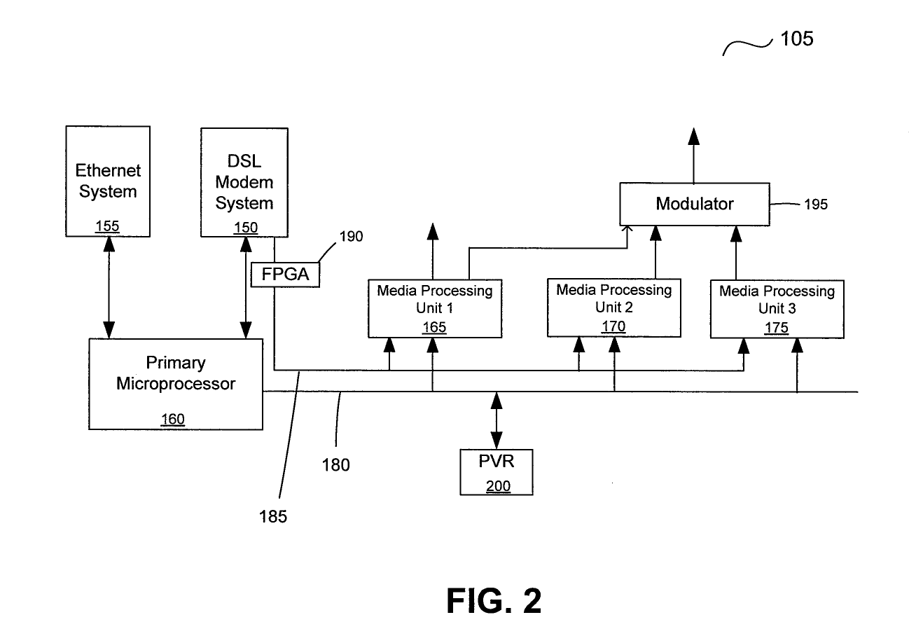

Each of the first, second, and third televisions 115, 120, 125 are independently controllable either at the CPE 105 or by corresponding remote controls 130, 135, 140. These remote controls are typically RF based and can control the CPE 105 from locations within the residence without direct line of sight access to the CPE 105. For example, the third remote control 140 corresponds to the third television 125. This remote control 140 can control functions at the CPE 105 such as changing the channel that is being decoded and sent to the third television 125. This process is described further with reference to FIG. 2.

As shown in FIG. 1, the CPE 105 can be connected to a home computer 145 or an in-home network 130 such as an Ethernet or wireless system. The CPE 105 acts to direct data that it receives from, for example, a Web site, a data network, a programming provider, etc., to the home computer 145, and also receives data from the home computer 145 and transmits it to the broadband IP network. The CPE 105 also acts to direct data between the home computer 145 and the CPE 105. For example, the CPE 105 could receive home videos from the computer 145 and provide those home videos to one of the three televisions 115, 120, 125. Similarly, a video stream received at the CPE 105 could be routed to and stored at the home computer 145.

Referring now to FIG. 2, it is a block diagram of one embodiment of the CPE 105. This embodiment includes an DSL modem 150 and an Ethernet system 155 that relay input data to the primary microprocessor 160. The DSL modem 150 can provide access to Internet service providers, video-on-demand providers, audio providers, and television programming providers. Video and audio service can be received at the CPE 105 in many formats, although the currently preferred format is MPEG-2 encapsulated in IP.

The Ethernet system 155 is configured to provide a connection to an Ethernet network. One embodiment of the Ethernet system 155 supports 10 Base-T, 10 Base-T full duplex, 100 Base-T, and/or 100 Base-T full duplex. Of course, the Ethernet system 155 can be configured to support many transport modes. And on a broad scale, the Ethernet system 155 can be replaced with other types of network connection systems.

The DSL modem 150, in this embodiment, is configured to extract IP packets from incoming data and place the extracted packets on the data bus 180, which in this embodiment is a PCI bus. The IP packets can alternatively be sent to the media processing units 165, 170, 175 via the MPEG bus 185 and the field programmable gate array 190. The MPEG bus is generally connected directly to the decoder portion of the media processing units 165, 170, 175. Accordingly, packets arriving over the MPEG bus 185 avoid some of the processing that is required for packets that arrive over the data bus 180.

Generally, the DSL modem 150 or the FPGA 190 decide which packets to route via the MPEG bus 185 or the data bus 180. Note that the DSL modem and the FPGA can be integrated into a single unit. Also note that the FPGA can be replaced with any type of logic unit.

Factors in deciding which bus to use in the transfer include: type of data, whether the data is encrypted, whether the data requires further processing prior to decoding; whether the data can be directly decoded. For example, the DSL modem 150 could determine that the incoming packets are encrypted and route those packets to the media processing unit 2 (170) via the data bus 180. Other incoming packets may be ready for direct decoding and routed to the same media processing unit via the MPEG bus 185.

Typically, the DSL modem 150 extracts the IP packets associated with a particular channel of video data that is requested by one of the media processing units 165, 170, 175. The extracted packets can be addressed to a particular media processing unit 165, 170, 175 based on the requests by that particular media processing unit.

The media processing units 165, 170, 175 accept the appropriate data from the data bus 180, decode and decrypt that data (if necessary), and provide the data in viewable form to the television corresponding to the media processing unit. This data can be provided to the appropriate television in a variety of ways. For example, the first media processing unit includes direct outputs for driving the television. The direct output can include any of the outputs typical to the video industry. The direct output can also include direct audio outputs, including digital audio outputs.

The media processing units, in this embodiment, can be configured to provide decoded data to remotely located televisions in an analog format. For example, the media processing units can output a decoded video signal to a modulator 195. The modulator 195 can then convert the decoded signal into a VHF signal that can be transmitted to the remotely located televisions. For example, the modulator 195 can convert the data output from the second media processing unit to VHF channel 3. Thus, any television that is connected to the modulator 195 and that is tuned to channel 3 can view the decoded signal from the second media processing unit. Similarly, any television that is connected to the modulator 195 and that is tuned, for example, to channel 7 can display the decoded signal from the third media processing unit.

The modulator 195 can be connected to the remotely located televisions by an internal network 130. Typically, this internal network is based on in-home coaxial cable wiring. Many houses are wired with a coaxial cable, and the modulator 195 takes advantage of this fact by transmitting the video signal over the existing cable. Thus, the consumer does not need to install new wiring from the CPE to the remotely located televisions. In certain embodiments, however, new network wiring can be installed or a wireless network can be used.

In certain embodiments of the present invention, a digital media recorder (DMR) 200 can be attached to the data bus 180. The DMR 200 can record programming output by the communications processing unit 160 and subsequently transmit that programming to a particular one of the media processing units for viewing. For example, the DMR 200 could transmit the program data encapsulated over the data bus 180 to a particular one of the media processing units 165, 170, 175.

The DMR functions can be controlled by any of the media processing units 165, 170, 175. Thus, a particular media processing unit could request that the DMR 200 retrieve certain program data and send it to that media processing unit. Certain DMR functions for certain media processing units, however, may be restricted based on set-up configurations or parental controls.

Still referring to FIG. 2, the DMR 200 in this embodiment could be partitioned into logical storage units so that each media processing unit is associated with only one portion of the DMR 200. Users would essentially experience three separate DMRs—one for each media processing unit. Alternatively, the DMR 200 could operate as a single DMR 200 with a common storage area. And in this embodiment, users would experience a shared DMR for all three media processing units.

In yet another embodiment, the DMR 200 could include a common storage area and separate private storage areas. In this embodiment, users would experience an independent DMR 200 for each media processing unit, but also have the ability to share programming with the other media processing units or other logical DMR units. In all of these embodiments, the DMR 200 could be controlled from the user interface associated with the particular media processing units. This user interface is discussed below.

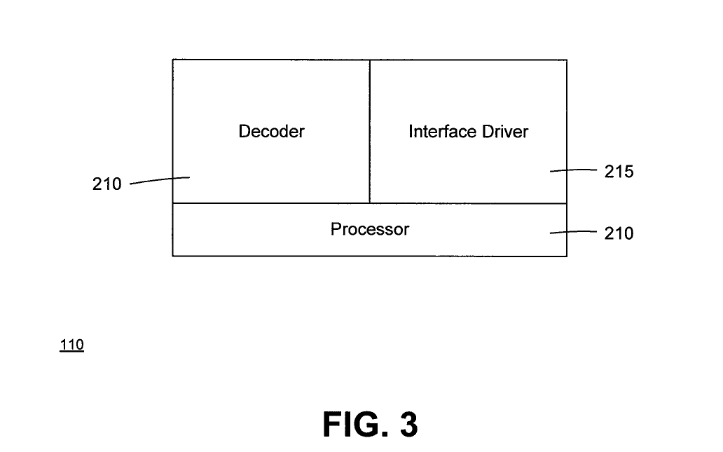

Referring now to FIG. 3, it is a block diagram of one exemplary media processing unit 165, 170, or 175. This embodiment includes a processor 205, a decoder 210, and an interface driver 215. The processor 205 can be any type of microprocessor or microcontroller. It can operate directly as a decoder, or it can control an integrated or free-standing decoder. The processor 205 can also decrypt video packets if necessary and request routing of video packets from the communications processing unit to the corresponding media processing unit. The processor 205 can also operate software for the interface driver.

The interface driver 215 can generate an interactive program guide, including a video-on-demand guide, a program guide, and/or setup controls. The data for the interactive program guide could be stored local to the media processing unit 165, 170, 175 or stored elsewhere in the CPE 105. And in certain cases, the data for the interactive program guide may be stored outside the CPE 105 such that the interface driver 215 would need to request the data from an outside source.

The interface driver 215 could enable the creation of parental controls and customized user setups. The settings for a customized program guide and/or the parental controls can be stored in a memory local to the media processing unit or in another memory location within the CPE 105.

Notably, each media processing unit 165, 170, 175 can incorporate its own interface driver 215. Thus, the user experiences a different interactive program guide for each media processing unit and associated television. In other embodiments, the interface driver 215 is centralized and individual threads are spun for each media processing unit, thereby allowing each media processing unit 165, 170, 175 to appear to have a unique interface driver. In either embodiment, however, the interface driver 215 for a particular media processing unit can be controlled through the remote control corresponding to the media processing unit. For example, the interface driver 215 in the first media processing unit 165 can be controlled by the remote control 130 corresponding to that media processing unit 165.

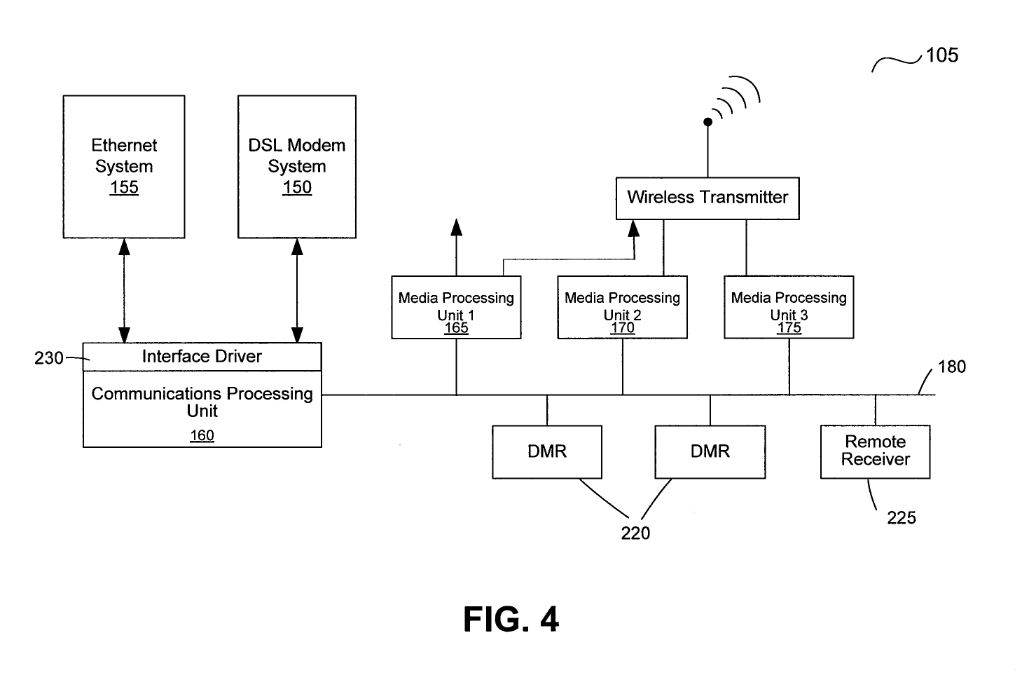

Referring now to FIG. 4, it is a block diagram of another embodiment of the CPE 105. This embodiment includes several of the same components as the version shown in FIG. 2. The common components are not necessarily discussed further.

This version of the CPE 105 includes a distributed DMR 220. That is, the storage for video and audio programming can be distributed among multiple devices. The DMR functionality or DMR data storage duties can even be assigned to a home computer 145 attached to the CPE 105. Data can be routed and stored within the distributed storage according to any of the well-known methods.

This version of the CPE 105 also includes a remote control receiver 225 for receiving instructions from the remote controls. This receiver is attached directly to the data bus 180, which can be a PCI bus. The receiver can also be distributed among the individual media processing units 165, 170, 175.

The interface driver 230 in this embodiment is remotely located from the media processing units 165, 170, 175. Notably, the interface driver 230 is capable of simultaneously providing a unique user interface for each of the media processing units 165, 170, 175. In essence, the interface driver 230 can operate separate interface threads for each media processing unit, thereby providing each media processing unit with a potentially unique user interface. And whether distributed or centralized, the interface driver can also include a master interface where overall system settings can be established. For example, parental controls can be applied to all media processing units through this master interface. Settings for the master interface could be stored local to the media processing units, local to the centralized interface driver, or somewhere else in the CPE 105.

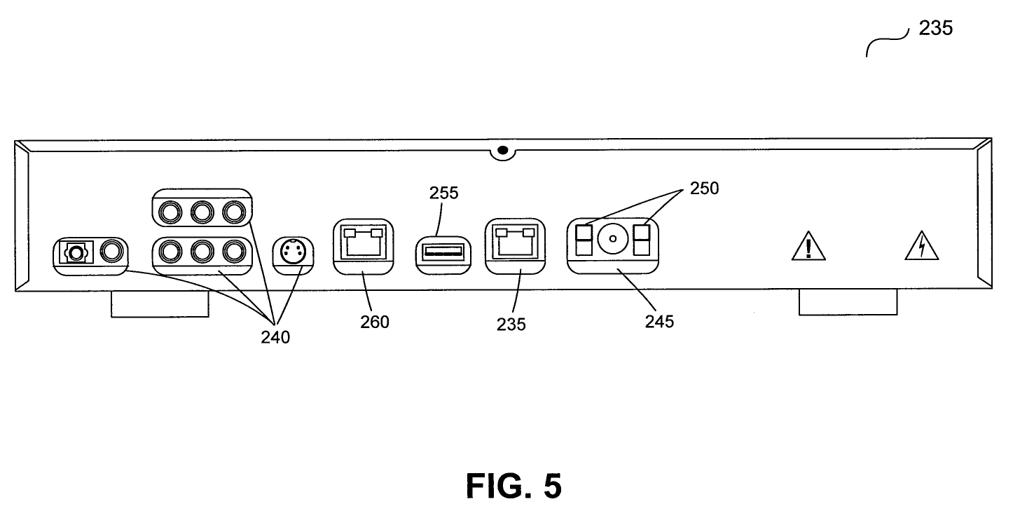

Referring now to FIG. 5, it is an illustration 235 of the connectors used by an exemplary CPE 105. These connectors are defined by standards that are widely available. Accordingly, the specifics of the connectors are not described herein. Briefly, however, this version of the CPE includes a power supply input (not shown), a DSL interface (including caller identification capability) 235, direct television output interfaces including an S-video output 240, a remote television output interface with a channel selector 245, 250, an RF receiver supporting multiple remote controllers (not shown), a USB port 255, and a 10/100 BT Ethernet LAN port 260. Other embodiments may include new connectors or may eliminate any of these connectors.

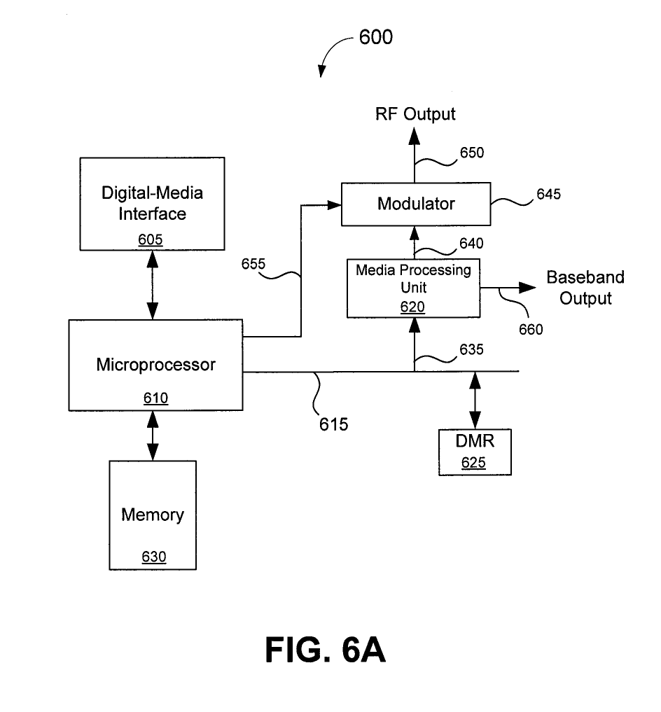

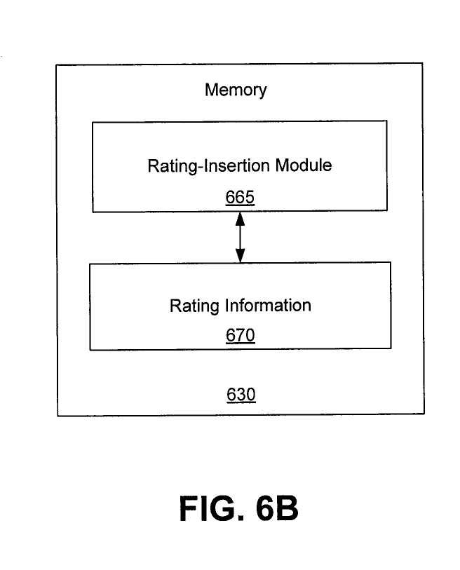

Referring now to FIG. 6A, it is a block diagram of a customer premises unit (CPE) 600 constructed according to yet another embodiment of the present invention. This illustrative embodiment includes parental-control capabilities. CPE 600 is configured to receive digital content at a premises from any of a variety of sources and to receive, at the premises, rating information for the various programs in the digital content. In this context, “premises” refers to a residence, commercial building, or group of buildings, whether residential or commercial, on a particular tract of land. CPE 600 decodes the digital content to produce decoded content, embeds rating indicators with the respective programs in the decoded content based on the rating information, and modulates the rated-decoded content including the rating indicators to produce rated-modulated content that includes the embedded rating indicators.

The rated-modulated content is transmitted to one or more analog televisions on the premises that are capable of selectively blocking programs based on the embedded rating indicators. In short, CPE 600 restores rating information that would otherwise be lost when content is converted from digital format to analog format for distribution to analog televisions within a premises. This enables a parent or other authorized user to exercise control over what classes of content may be viewed on a particular analog television by simply configuring the analog television to block particular classes of content.

In one embodiment, the embedded rating indicators are encoded in the vertical blanking interval of an NTSC signal and are compatible with well-known V-chip technology. As those skilled in the art are aware, V-chip technology is similar to that used for providing closed-captioning and emergency-alert services. In V-chip technology, the rating data is encoded within the vertical blanking interval of the NTSC signal using frequency-shift-keying (FSK) modulation. Further details regarding V-chip technology are described in U.S. Pat. Nos. 4,554,584 and 5,828,402, both of which are herein incorporated by reference.

A parent or other authorized user can configure an analog television equipped with a V-chip to block particular categories of content. For example, a parent might decide to configure the V-chip in a child's television to block all programming bearing a Federal Communications Commission (FCC) rating of “TV-14” (“Parents Strongly Cautioned”) or “TV-MA” (“Mature Audiences Only”). In other embodiments, the rating indicators are restored to the analog video signal in accordance with a predetermined format other than the V-chip standard.

In FIG. 6A, digital-media interface 605 receives digital content at the premises where CPE 600 is located. The received digital content may include, for example, movies, episodic television programs, documentaries, and news, and the digital content may be received from any of a variety of sources, including, without limitation, digital cable, digital satellite, digital subscriber loop (DSL), optical fiber, and one or more on-premises digital-media recorders (DMRs). In some embodiments, digital-media interface 605 is configured to receive digital content from multiple sources.

Depending on the particular embodiment, digital-media interface 605 may include a DSL modem, an Ethernet interface, or other suitable communication interface for receiving digital content. In some embodiments, digital-media interface 605 receives the digital content via an Internet-Protocol (IP) connection. In other embodiments, the digital content may be received via protocols other than IP.

The received digital content may be in any of a variety of formats, including, without limitation, MPEG-2, MPEG-4, Windows Media Video (WMV), or a combination of formats, depending on the particular content.

In FIG. 6A, microprocessor 610 communications over data bus 615 with media processing unit 620 and optional DMR 625 (e.g., a digital video recorder). DMR 625 is shown primarily for illustration purposes and is not necessarily present in all embodiments. In some embodiments, a user can optionally connect DRM 625 with data bus 615. Microprocessor 610 is also connected with memory 630. Digital content 635 is fed to media processing unit 620, which outputs decoded content 640. In one embodiment, decoded content 640 includes separate baseband analog video and audio signals. Modulator 645 modulates decoded content 640 onto a predetermined carrier frequency to produce analog radio-frequency (RF) rated-modulated content (e.g., an NTSC signal) at RF output 650.

Modulator 645, under the control of microprocessor 610 via control line 655, embeds a rating indicator with a given program in the decoded content. That is, microprocessor 610 determines (e.g., based on a stored programming schedule) that a particular program is being transmitted from RF output 650 and instructs modulator 645 via control line 655 to embed a rating indicator corresponding to rating information associated with that particular program. For example, the particular program might have an FCC rating of “TV-PG” (“Parental Guidance Suggested”). Modulator 645 embeds into decoded content 640 a rating indicator in the form of, e.g., ASCII text or a predetermined bit pattern that uniquely corresponds to the “TV-PG” rating to produce rated-decoded content including the particular program. Modulator 645 modulates the rated-decoded content onto a particular carrier frequency to produce, at RF output 650, rated-modulated content. The rated-modulated content is suitable for transmission to one or more analog televisions on the premises that are capable of selectively blocking the particular program based on the rating indicator embedded with the particular program.

As mentioned above, in some embodiments the rating indicators are compatible with V-chip technology. In the example just discussed, an analog television whose V-chip has been configured to block “TV-PG” programs would automatically block the particular program based on the embedded V-chip-compatible rating indicator.

As in the foregoing embodiments, to receive the analog signal (rated-modulated content), a viewer tunes the analog television to the appropriate VHF or UHF carrier frequency matching that of the rated-modulated content. A viewer can select a specific channel within the video stream by inputting a command to CPE 600 via controls (not shown in FIG. 6A) on CPE 600 itself or via an RF remote control, as described above. In some embodiments, the rated-modulated content is transmitted to the analog televisions via an existing coaxial network within the premises. In other embodiments, wireless distribution within the premises is used instead of or in addition to coaxial distribution.

In some embodiments, media processing unit 620 also includes baseband output 660 for outputting baseband video and audio signals in formats such as RCA, separate video (S-Video), or High-Definition Multimedia Interface (HDMI).

FIG. 6B is a functional diagram of the memory 630 of CPE 600 shown in FIG. 6A according to an illustrative embodiment of the present invention. Memory 630 can be any kind of memory, including, without limitation, random-access memory (RAM), read-only memory (ROM), flash memory, magnetic memory (e.g., a hard disk drive), optical memory, or a combination thereof. In the illustrative embodiment of FIG. 6B, memory 630 includes rating-insertion module 665, a program that manages the receipt, storage, and application of rating information 670. In one embodiment, rating-insertion module 665 is software or firmware that is executed by microprocessor 610. In general, the functionality of rating-insertion module 665 can be implemented in software, firmware, hardware, or any combination or sub-combination thereof. In this embodiment, rating-insertion module 665 communicates with modulator 645 via control line 655 to embed the appropriate rating indicator with each program in the decoded content 640 for which rating information 670 is available.

Rating information 670 may be received in advance of the associated programming in some embodiments. For example, some digital content providers transmit an electronic programming guide (EPG) up to two weeks before the applicable programs are broadcast. In one embodiment, CPE 600 is configured to store such advance rating information 670 for later use in inserting the rating indicators. By consulting the EPG or similar data, microprocessor 610 can determine what program is being transmitted from RF output 650 (the rated-modulated content) at any given time and can look up the corresponding stored rating information 670 to determine the corresponding rating indicator to be embedded in the out-going analog signal.

In another embodiment, rating information is obtained from a user interface associated with a vendor or content provider offering video-on-demand (VOD) programming. Such a user interface, often implemented on a Web site using Hypertext Markup Language (HTML) or Extensible Markup Language (XML), allows a viewer to select particular digital content on-line for immediate viewing or downloading. Such a user interface typically includes metadata that can be read by rating-insertion module 665 in response to the user's selection of a particular VOD program. This metadata typically includes rating information for the selected program.

In some situations, the rating information that CPE 600 receives for a particular program may be in accordance with a different rating system than that upon which the rating indicators are based. For example, a particular program might be a movie with a Motion Picture Association of America (MPAA) rating of “R,” for which there is no direct counterpart in the FCC rating system for television programs. In some embodiments, CPE 600 is configured to convert received rating information from one rating system to another. For example, in an embodiment in which CPE 600 is configured to output V-chip-compatible rated-modulated content, an MPAA rating (“G,” “PG,” “PG-13,” “R,” or “NC-17”) is converted to a predetermined rating (“TV-Y,” “TV-Y7,” “TV-G,” “TV-PG,” “TV-14,” or “TV-MA”) in the FCC rating system. In such embodiments, memory 630 includes a simple lookup table that rating-insertion module 665 consults to map the MPAA ratings to their corresponding FCC ratings.

In some embodiments, CPE 600 includes multiple media processing units 620, each including a separate decoder configured to decode a particular portion of the digital content 635 to produce a corresponding decoded-content stream similar to decoded content 640. In one embodiment, CPE 600 includes three media processing units 620. Such an embodiment is similar to that shown in FIG. 6A, except that there is a separate media processing unit 620 including a decoder (see, e.g., decoder 210 in FIG. 3) for each stream, and modulator 645 is configured to accept multiple decoded-content inputs such as decoded content 640. In such an embodiment, rating-insertion module 665 is also configured to embed rating indicators in multiple decoded-content streams.

Modulator 645, in such an embodiment, is configured to modulate the decoded content (640) produced by a given media processing unit 620 onto its own unique carrier frequency. Thus, a viewer can tune an analog television on the premises to any of the predetermined carrier frequencies to receive a particular stream. Once tuned to a particular carrier frequency carrying a particular stream, the analog television can selectively block programs based on the embedded rating indicators within that stream, as described above.

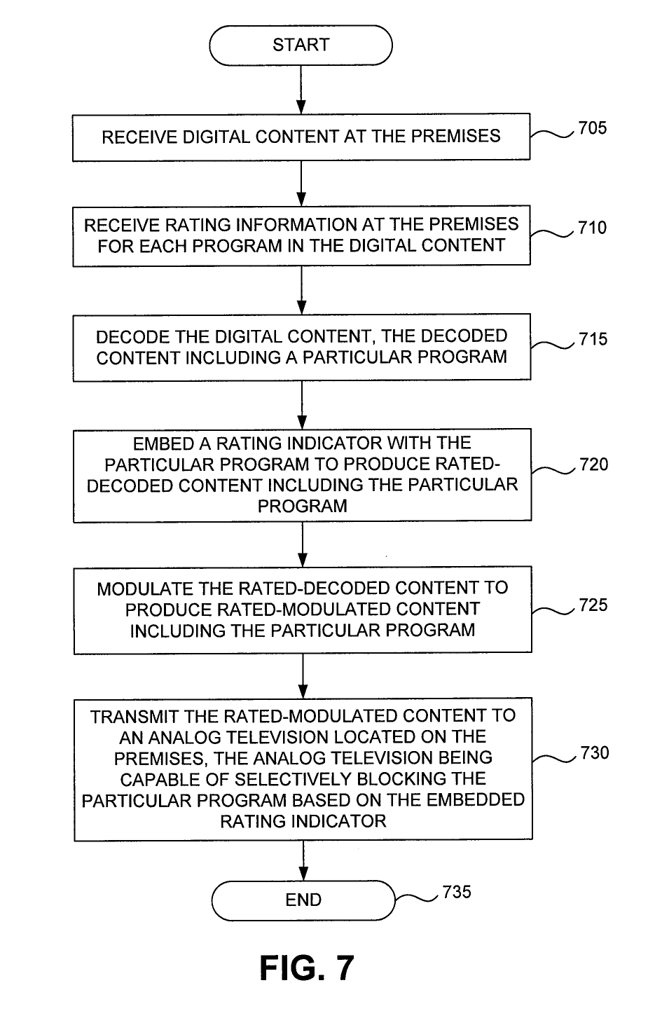

FIG. 7 is a flowchart of a method for controlling access to media content within a premises in accordance with an illustrative embodiment of the present invention. At 705, digital-media interface 605 receives digital content 635 at the premises, the digital content 635 including separate programs. The separate programs can be temporally separate, from separate sources, or both. At 710, rating-insertion module 665 receives, at the premises, rating information for each of the separate programs in the digital content 635. This rating information enables rating-insertion module 665 to associate one of a plurality of rating indicators with each of the separate programs for which rating information is available. Each rating indicator identifies a particular class of content (e.g., “TV-PG”).

At 715, media processing unit 620 decodes digital content 635 to produce decoded content 640, the decoded content including a particular program among the separate programs. At 720, rating-insertion module 665 embeds with the particular program in decoded content 640 a rating indicator associated with the particular program to produce rated-decoded content that includes the particular program. At 725, modulator 745 modulates the rated-decoded content to produce, at RF output 650, rated-modulated content that includes the particular program with its embedded rating indicator. At 730, CPE 600 transmits, from RF Output 650, the rated-modulated content to an analog television on the premises that is capable of selectively blocking the particular program based on the embedded rating indicator. At 735, the process terminates.

In conclusion, the present invention provides, among other things, a method and system for controlling access to media content distributed within a premises. Although the system is primarily described in terms of video content, various embodiments of the invention can process and distribute any type of data, including video, audio, textual, etc. Moreover, the principles of the invention can be applied to television-signal standards other than NTSC such as PAL and SECAM. Those skilled in the art can readily recognize that numerous variations and substitutions may be made in the invention, its use, and its configuration to achieve substantially the same results as achieved by the embodiments described herein. Accordingly, there is no intention to limit the invention to the disclosed illustrative forms. Many variations, modifications, and alternative constructions fall within the scope and spirit of the disclosed invention as expressed in the claims.

What is claimed is:

1. A method for controlling access to media content distributed within a premises, the method comprising:
receiving digital content at the premises, the digital content including separate programs;
receiving at the premises, for each of the separate programs, rating information, the rating information enabling one of a plurality of rating indicators to be associated with each of the separate programs, each of the plurality of rating indicators identifying a particular class of content;
decoding the digital content to produce decoded content, the decoded content including one of the separate programs;
embedding with the one of the separate programs in the decoded content a rating indicator associated with the one of the separate programs to produce rated-decoded content including the one of the separate programs;
modulating the rated-decoded content to produce rated-modulated content including the one of the separate programs; and
transmitting the rated-modulated content to an analog television located on the premises, wherein the analog television is capable of selectively blocking the one of the separate programs based on the embedded rating indicator.

2. The method of claim 1, wherein the digital content is received from a plurality of sources.

3. The method of claim 2, wherein the plurality of sources include at least one of digital satellite, digital cable, optical fiber, digital subscriber loop (DSL), and an on-premises digital-media recorder.

4. The method of claim 1, wherein the premises are a residence.

5. The method of claim 1, wherein the rating information is in accordance with a rating system defined for movies by the Motion Picture Association of America (MPAA).

6. The method of claim 1, wherein the rating information is in accordance with a rating system defined for television programs by the Federal Communications Commission (FCC).

7. The method of claim 1, further comprising:
converting the rating information for the one of the separate programs from a first rating system to a second rating system.

8. The method of claim 7, wherein the first rating system is a rating system defined for movies by the Motion Picture Association of America (MPAA) and the second rating system is a rating system defined for television programs by the Federal Communications Commission (FCC).

9. The method of claim 1, wherein the embedded rating indicator is compatible with a V-chip in the analog television, the V-chip being capable of selectively blocking one or more classes of content in the rated-modulated content in accordance with viewing restrictions specified by an authorized user.

10. The method of claim 1, wherein the embedded rating indicator is encoded in a vertical blanking interval of the rated-modulated content.

11. The method of claim 1, wherein the rating information is received in an electronic programming guide prior to receipt of the digital content and the rating information for the one of the separate programs is stored for later use in embedding with the one of the separate programs in the decoded content the rating indicator associated with the one of the separate programs.

12. The method of claim 1, wherein the rating information is obtained from a user interface for selection of a video-on-demand program in response to a user's selection of the video-on-demand program via the user interface.

13. The method of claim 1, wherein the digital content is received in at least one of MPEG-2, MPEG-4, and Windows Media Video (WMV) format via an Internet-Protocol (IP) connection.

14. A device for controlling access to media content distributed within a premises, the device comprising:
a digital-media interface configured to receive, at the premises, digital content including a particular program;
a decoder configured to decode the digital content to produce decoded content including the particular program;
a rating-insertion module configured to:
receive at the premises rating information for the particular program; and
embed with the particular program in the decoded content a rating indicator corresponding to the rating information to produce rated-decoded content including the particular program, the rating indicator being selected from a plurality of rating indicators, each rating indicator in the plurality of rating indicators identifying a particular class of content; and
a modulator configured to modulate the rated-decoded content to produce rated-modulated content including the particular program for transmission to an analog television on the premises, wherein the analog television is capable of selectively blocking the particular program based on the embedded rating indicator.

15. The device of claim 14, wherein the device includes a plurality of decoders, each decoder in the plurality of decoders being configured to decode a particular portion of the digital content to produce a corresponding decoded-content stream.

16. The device of claim 14, wherein the digital-media interface is configured to receive the digital content from a plurality of sources.

17. The device of claim 16, wherein the plurality of sources include at least one of digital satellite, digital cable, optical fiber, digital subscriber loop (DSL), and an on-premises digital-media recorder.

18. The device of claim 14, wherein the rating information is in accordance with a rating system defined for movies by the Motion Picture Association of America (MPAA).

19. The device of claim 14, wherein the rating information is in accordance with a rating system defined for television programs by the Federal Communications Commission (FCC).

20. The device of claim 14, wherein the rating-insertion module is configured to convert the rating information for the particular program from a first rating system to a second rating system.

21. The device of claim 20, wherein the first rating system is a rating system defined for movies by the Motion Picture Association of America (MPAA) and the second rating system is a rating system defined for television programs by the Federal Communications Commission (FCC).

22. The device of claim 14, wherein the embedded rating indicator is compatible with a V-chip in the analog television, the V-chip being capable of selectively blocking one or more classes of content in the rated-modulated content in accordance with viewing restrictions specified by an authorized user.

23. The device of claim 14, wherein the modulator is configured to encode the embedded rating indicator in a vertical blanking interval of the rated-modulated content.

24. The device of claim 14, wherein the rating-insertion module is configured to:
receive the rating information in an electronic programming guide prior to receipt of the digital content by the digital-media interface; and
store the rating information for later use in embedding with the particular program in the decoded content the rating indicator corresponding to the rating information.

25. The device of claim 14, wherein the rating-insertion module is configured to obtain the rating information from a user interface for selection of a video-on-demand program in response to a user's selection of the video-on-demand program via the user interface.

26. The device of claim 14, wherein the digital-media interface is configured to receive the digital content via an Internet-Protocol (IP) connection.

27. The device of claim 14, wherein the received digital content is encoded in at least one of MPEG-2, MPEG-4, and Windows Media Video (WMV) format.

28. A system for controlling access to media content distributed within a premises, the system comprising:
a digital-media interface configured to receive, at the premises, digital content including separate programs;
a first decoder configured to decode a first portion of the digital content to produce a first portion of decoded content including a first program;
a second decoder configured to decode a second portion of the digital content to produce a second portion of decoded content including a second program;
a rating-insertion module configured to:
receive at the premises rating information for each of the first and second programs;
embed with the first program in the first portion of decoded content a first rating indicator corresponding to the rating information for the first program to produce a first portion of rated-decoded content including the first program; and
embed with the second program in the second portion of decoded content a second rating indicator corresponding to the rating information for the second program to produce a second portion of rated-decoded content including the second program; and
a modulator configured to modulate, onto respective distinct first and second carrier frequencies, the first and second portions of rated-decoded content to produce first and second portions of rated-modulated content for transmission to an analog television on the premises, wherein the analog television is capable, when tuned to one of the first and second carrier frequencies, of selectively blocking whichever one of the first and second programs it receives based on the rating indicator embedded in the one of the first and second programs it receives.

29. The system of claim 28, wherein each of the first and second rating indicators is selected from a plurality of rating indicators, each rating indicator in the plurality of rating indicators identifying a particular class of content, and wherein each of the first and second embedded rating indicators is compatible with a V-chip in the analog television, the V-chip being capable of selectively blocking one or more classes of content in the first and second portions of rated-modulated content in accordance with viewing restrictions specified by an authorized user.
